(19) United States
(12) Patent Application Publication
(10) Pub. No.: US 2022/0325672 A1
(43) Pub. Date: Oct. 13, 2022

(54) SYSTEM FOR SUPPLYING HYDROGEN GAS TO ENGINE

(71) Applicant: HIT RESEARCH INSTITUTE CORPORATION, Fujisawa-shi, Kanagawa (JP)

(72) Inventors: Masanori ITO, Nerima-ku, Tokyo (JP); Yoshihiro JABANA, Asaka-Shi, Saitama (JP); Tsutomu HARADA, Fujisawa-shi, Kanagawa (JP)

(21) Appl. No.: 17/641,049

(22) PCT Filed: Oct. 27, 2020
(86) PCT No.: PCT/JP2020/040311

§ 371 Date: Mar. 7, 2022

(30) Foreign Application Priority Data
Oct. 30, 2019 (JP) 2019-196841
Jul. 3, 2020 (JP) 2020-115462

(51) Int. Cl. F02D 19/02; F02D 31/00; F02M 21/02

(52) U.S. Cl. CPC F02D 19/022; F02D 31/007; F02M 21/0206; F02M 21/0239; F02D 2200/101

(57) ABSTRACT

A system for supplying hydrogen gas to an engine is disclosed. The system includes a main line configured to send hydrogen gas produced in a hydrogen gas producer by electrolysis to a supply line; a sub-line configured to send hydrogen gas from a hydrogen absorbing alloy cylinder to the main line, a governor configured to maintain an engine rotation speed within certain range; and a control device. The governor sends a signal corresponding to the engine rotation speed to the control device. A pressure regulating valve is disposed in the sub-line to be downstream with respect to the hydrogen absorbing alloy cylinder to regulate a supply amount of added hydrogen. An opening degree of the valve is adjusted based on a signal from the control device corresponding to the opening degree of the valve for supplying the added hydrogen with an amount according to a load state of the engine.

### CROSS-REFERENCE TO RELATED APPLICATIONS

This application is the U.S. National Phase of International Application No. PCT/JP2020/040311, filed Oct. 27, 2020. This application claims priority to Japanese Patent Application No. 2019-196841 filed Oct. 30, 2019, and Japanese Patent Application No. 2020-115462 filed Jul. 3, 2020. The entire contents of those applications are incorporated by reference herein in their entireties.

### TECHNICAL FIELD

The present invention relates to a system for supplying hydrogen gas to air supply or to a gas fuel supply line, and relates to a system that enables long-term supply of hydrogen gas.

### BACKGROUND ART

Japanese Patent No. 6328186 proposes an addition of a trace amount (0.01 to 0.1 vol %) of hydrogen to air supply as a method for efficient combustion of a polymer liquid fuel such as gasoline, diesel, or heavy oil in an engine.

In the method, when the fuel is ignited, the hydrogen gas in the air supply is also ignited, and the combustion of the hydrogen gas promotes mixing of the polymer liquid fuel and the air supply because the flame propagation speed of the hydrogen gas is much faster than that of the polymer liquid fuel. Thus, complete combustion of the fuel is promoted. The method is believed to be especially effective for combustion systems with severe load fluctuations.

In order to apply, to a vessel or the like, the above-mentioned combustion with the addition of a trace amount of hydrogen to air supply, it is necessary to constantly supply hydrogen. The constant supply can be achieved by mounting a hydrogen production device on the vessel, or mounting a hydrogen cylinder or a cylinder filled with a hydrogen absorbing alloy on the vessel.

As an apparatus for producing hydrogen, the electrolysis apparatus described in Japanese Unexamined Patent Publication No. 2019-123899 is typically used. The electrolysis apparatus has a configuration in which pure water is electrolyzed by an electrolytic unit including a large number of connected cell stacks, and hydrogen gas produced by the electrolysis and water are sent to a gas-liquid separation device so as to take out hydrogen gas.

The produced hydrogen gas is usually filled and stored in a cylinder, or a larger amount of hydrogen can be filled and stored at a lower pressure when the cylinder filled with a hydrogen storage alloy is used.

Japanese Unexamined Patent Publication No. 2018-207728 describes a method, in which excess electric power to be generated based on renewable energy is predicted, hydrogen is produced using the predicted excess electric power, and the resulting hydrogen is filled and stored in a cylinder or the like.

### BRIEF SUMMARY

In the operation method disclosed in Japanese Patent No. 6328186, when an engine load fluctuates, even if a large amount of fuel is input, the fuel can be completely burned with the addition of an extremely small amount of hydrogen gas which is optimum according to the operating state of the engine. However, a vessel or the like uses an engine of an extremely large displacement and continuously operates such an engine for a long period of time, which requires a large amount of hydrogen.

The above-described water electrolysis apparatus requires an increase in the number of cell stacks to produce a larger amount of hydrogen gas, and the electrolysis apparatus using an electrolyte requires an increase in its volume. In some existing vessels or the like, such an electrolysis apparatus cannot be installed in their limited space such as an engine room.

It is possible to load a hydrogen cylinder or a hydrogen absorbing alloy cylinder. For the operation of an engine for a long period of time such as one week or one month, however, a large number of cylinders must be loaded, which is not realistic.

A system for supplying hydrogen gas to an engine according to a first aspect of the present invention in order to solve the above problems is a hydrogen gas supply system in which a hydrogen gas supply line is connected to an air supply line of the engine. The hydrogen gas supply line includes a main line for sending hydrogen gas produced in a hydrogen gas producer by electrolysis to the air supply line, and a sub-line for sending hydrogen gas from a hydrogen absorbing alloy cylinder to the main line.

A system for supplying hydrogen gas to an engine according to a second aspect of the present invention is a hydrogen gas supply system in which a hydrogen gas supply line is connected to an air supply line of the engine. The hydrogen gas supply line has, at one end, a hydrogen gas producer that uses electrolysis, a hydrogen absorbing alloy cylinder is disposed in the middle of the hydrogen gas supply line, so that the hydrogen gas produced by the hydrogen gas producer is temporarily sent to the hydrogen absorbing alloy cylinder, and then the hydrogen gas is supplied from the hydrogen absorbing alloy cylinder to the air supply line of the engine.

A system for supplying hydrogen gas to an engine according to a third aspect of the present invention is a hydrogen gas supply system configured to supply hydrogen gas to a gas fuel supply line of a gas engine. The hydrogen gas supply system includes a main line for sending hydrogen gas produced in a hydrogen gas producer by electrolysis to the gas fuel supply line, and a sub-line for sending hydrogen gas from a hydrogen absorbing alloy cylinder to the main line.

A system for supplying hydrogen gas to an engine according to a fourth aspect of the present invention is a hydrogen gas supply system configured to supply hydrogen gas to a gas fuel supply line of a gas engine. The hydrogen gas supply system includes a main line connected to, at one end, a hydrogen gas producer that uses electrolysis, and a hydrogen absorbing alloy cylinder is disposed in the middle of the main line, so that the hydrogen gas produced by the hydrogen gas producer is temporarily sent to the hydrogen absorbing alloy cylinder, and then the hydrogen gas is supplied from the hydrogen absorbing alloy cylinder to the gas fuel supply line of the engine.

In the basic configuration, the hydrogen gas supply line is composed of the main line and the sub-line as in the first aspect of the present invention, but another configuration is possible in which, for excess hydrogen gas to be produced, a third line is used to store the excess hydrogen in the hydrogen absorbing alloy cylinder, the third line connecting between the hydrogen gas producer and the hydrogen absorbing alloy cylinder.

According to the hydrogen gas supply system of the present invention, without selecting a hydrogen gas producer for producing a large amount of hydrogen per unit time, even if the required amount of hydrogen to be added increases according to a fluctuation in the load on the engine, the increase can be covered with the hydrogen from the hydrogen absorbing alloy cylinder. Thus, a relatively small device can be used as the hydrogen gas producer, and the degree of freedom of installation is increased.

According to the hydrogen gas supply system according to the second aspect of the present invention, the hydrogen gas from the hydrogen gas producer is always supplied to the hydrogen absorbing alloy cylinder, and thereby the hydrogen absorbing alloy cylinder serves as a storage, and as in the first aspect of the present invention, a relatively small device can be used as the hydrogen gas producer, and the degree of freedom of installation is increased.

According to the third and fourth aspects of the present invention, even when hydrogen gas is supplied to the gas fuel line in the system, it is possible to continuously supply hydrogen gas for a long period of time.

A plurality of hydrogen producers may be used. In this case, a various number of the hydrogen producers can be operated depending on the fluctuation of the engine load.

### BRIEF DESCRIPTION OF THE DRAWINGS

FIG. 1 is an overall view of a hydrogen gas supply system according to the first aspect of the present invention.

FIG. 2A is an overall view of a hydrogen gas supply system according to another embodiment of the first aspect of the present invention.

FIG. 2B is a diagram showing another example of a storage configuration of hydrogen absorbing alloy cylinders.

FIG. 2C is a diagram showing another example of an arrangement of a plurality of hydrogen absorbing alloy cylinders.

FIG. 3A is a diagram showing a state in which one of the hydrogen absorbing alloy cylinders of the embodiment shown in FIGS. 2A-2C is filled with hydrogen while hydrogen is supplied to air supply.

FIG. 3B is a diagram showing a state in which another one of the hydrogen absorbing alloy cylinders is filled with hydrogen while hydrogen is supplied to air supply.

FIG. 4 is an overall view of a hydrogen gas supply system according to a second aspect of the present invention.

FIG. 5 is an overall view of a hydrogen gas supply system incorporating the elements of the first aspect of the present invention and the second aspect of the present invention.

FIG. 6 is an overall view of a system for supplying hydrogen gas to a gas fuel supply line.

FIG. 7 is an overall view of another embodiment of a system for supplying hydrogen gas to a gas fuel supply line.

### DETAILED DESCRIPTION

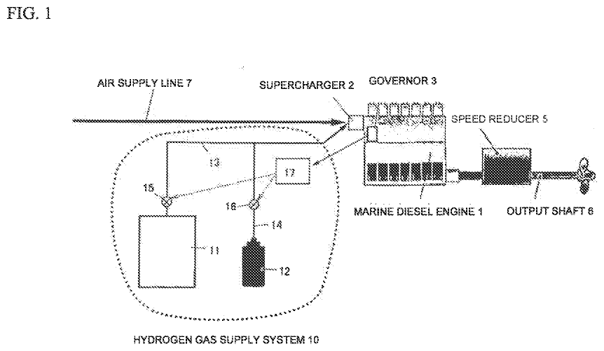

Hereinafter, embodiments of the present invention will be described with reference to the accompanying drawings. FIG. 1 shows an example in which a hydrogen gas supply system according to the first aspect of the present invention is applied to a marine diesel engine. The marine diesel engine 1 includes a supercharger 2, a governor 3 to maintain the engine rotation speed within a certain range even if the load fluctuates, a speed reducer 5 (not equipped in a low-speed engine) for decreasing the rotation of the engine, and a propeller shaft 6 (output shaft).

An air supply line (piping) 7 for taking in outside air into the engine has, at one end, the supercharger 2. To the air supply line 7 including the supercharger 2, a trace amount of hydrogen gas is sent via the hydrogen gas supply system 10. (In an engine having no supercharger, hydrogen is put into an air filter.)

The hydrogen gas supply system 10 includes a hydrogen gas producer 11 for electrolyzing pure water to produce hydrogen gas (oxygen gas), and a hydrogen absorbing alloy cylinder (canister) 12 filled with a hydrogen storage alloy.

The hydrogen gas produced by the hydrogen gas producer 11 is supplied to the air supply line 7 (including the supercharger 2) via a main line (piping) 13. To the main line 13, a sub-line 14 is connected for supplying the hydrogen gas contained in a hydrogen absorbing alloy cylinder 12. The main line 13 and the sub-line 14 have pressure regulating valves 15 and 16.

The governor 3 sends a signal corresponding to an engine speed to a control device 17. The control device 17 sends a signal to the pressure regulating valves 15 and 16, in which the signal corresponds to a valve opening degree for supplying an amount of hydrogen to be added according to the load state of the engine.

For example, for a small load fluctuation of the engine, the pressure regulating valve 15 is opened by a predetermined degree while the pressure regulating valve 16 is closed, the hydrogen gas in the hydrogen absorbing alloy cylinder 12 is not used, and only the hydrogen gas produced by the hydrogen gas producer 11 is used. For a large load fluctuation of the engine, both the pressure regulating valves 15 and 16 are opened, and the hydrogen gas in the hydrogen absorbing alloy cylinder 12 is also used.

Note that the hydrogen gas pressure in the hydrogen absorbing alloy cylinder 12 is about 4 atm, and the pressure in the storage unit of hydrogen gas produced by the hydrogen gas producer 11 is about 7 atm. Accordingly, the hydrogen gas in the hydrogen absorbing alloy cylinder 12 does not flow toward the hydrogen gas producer 11.

When the hydrogen gas in the hydrogen absorbing alloy cylinder 12 is exhausted, the cylinder 12 is replaced with a new cylinder. Note that filling the hydrogen absorbing alloy cylinder 12 with hydrogen gas can be achieved through connection to a high-pressure (e.g., 7 atm) hydrogen generation source. As such, the hydrogen absorbing alloy cylinder 12, when empty, may be connected to the hydrogen gas producer 11, which makes the cylinder 12 to be filled with hydrogen.

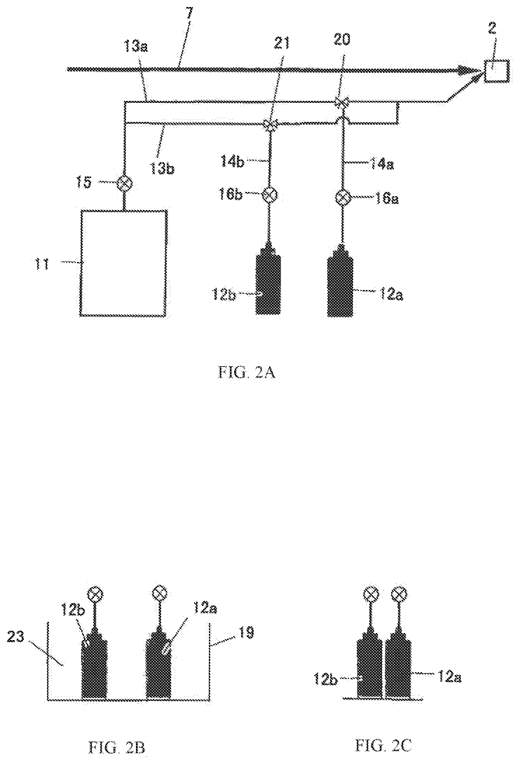

FIG. 2A shows a configuration that eliminates the replacement of the hydrogen absorbing alloy cylinder by preparing hydrogen absorbing alloy cylinders 12a and 12b. That is, the main line is branched into main lines 13a and 13b, the main line 13a being connected to a sub-line 14a of the hydrogen absorbing alloy cylinder 12a via a three-way valve 16a, the main line 13b being connected to a sub-line 14b of the hydrogen absorbing alloy cylinder 12b via a three-way valve 16b.

An exothermic reaction occurs when hydrogen is stored in a hydrogen absorbing alloy cylinder, and an endothermic reaction occurs when hydrogen is released from the hydrogen absorbing alloy cylinder. Accordingly, as shown in FIG. 2B, the hydrogen absorbing alloy cylinders 12a and 12b can be installed in a tank 19 filled with a temperature change preventive material 23 such as water or gel.

Alternatively, as shown in FIG. 2C, the hydrogen absorbing alloy cylinders 12a and 12b can be tied together using a metal belt or the like that has a good heat transfer so as to offset the exothermic and endothermic reactions.

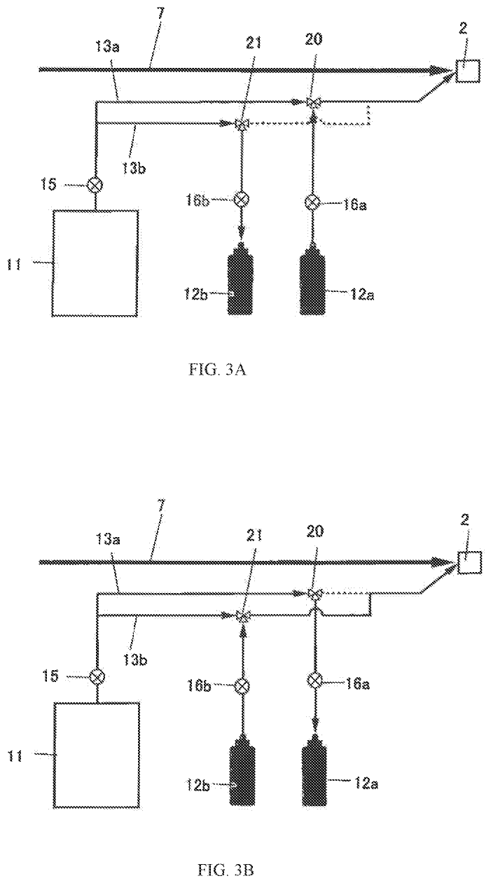

When the hydrogen absorbing alloy cylinder 12a is used for hydrogen addition, as shown in FIG. 3A, the control device 17 outputs a signal to operate a three-way valve 21, so that the hydrogen gas from the hydrogen gas producer 11 is filled in the hydrogen absorbing alloy cylinder 12b. In parallel with this, hydrogen gas is sent from the hydrogen absorbing alloy cylinder 12a to the main line 13a when necessary, and is added to the hydrogen gas from the hydrogen gas producer 11 to be supplied to air supply.

When the hydrogen absorbing alloy cylinder 12a is filled with hydrogen, as shown in FIG. 3B, the control device 17 outputs a signal to operate a three-way valve 20, so that the hydrogen from the hydrogen gas producer 11 is filled in the hydrogen absorbing alloy cylinder 12a. In parallel with this, hydrogen gas is sent from the hydrogen absorbing alloy cylinder 12b to the main line 13b when necessary, and is added to the hydrogen gas from the hydrogen gas producer 11 to be supplied to air supply.

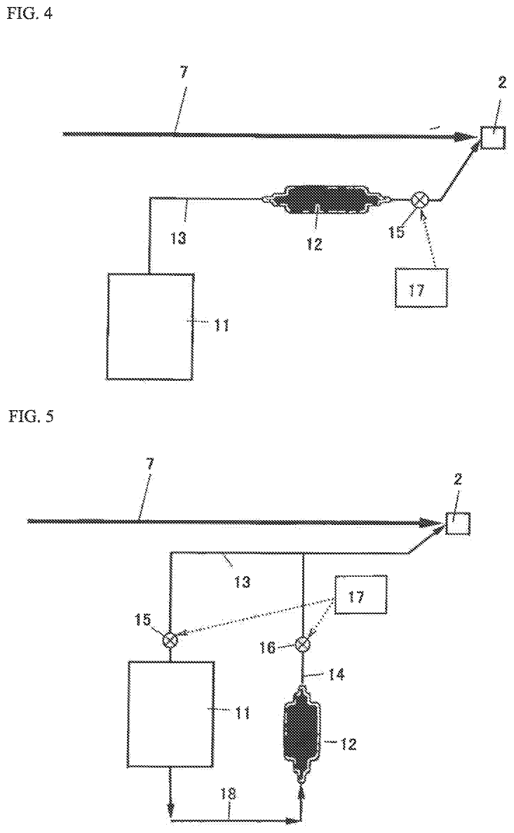

FIG. 4 shows an example in which a hydrogen gas supply system according to the second aspect of the present invention is applied to a marine diesel engine. In the example, the hydrogen absorbing alloy cylinder 12 is disposed in the middle of the main line 13. The hydrogen gas produced by the hydrogen gas producer 11 is sent to the hydrogen absorbing alloy cylinder 12, temporarily stored in the hydrogen absorbing alloy cylinder 12, and then sent to the air supply line 7 (including the supercharger 2) via the main line 13.

The hydrogen absorbing alloy cylinder 12 shown in FIG. 4 has nozzles at both ends, one for discharging hydrogen gas and the other for filling hydrogen gas from the outside. To obtain the hydrogen absorbing alloy cylinder 12 of the configuration, two hydrogen absorbing alloy cylinders 12 shown in FIG. 1 may be used to be cut in the direction orthogonal to the axis, so that the two half-cylinders having nozzles are welded.

In the example shown in FIG. 4, hydrogen gas is always supplied to the air supply line 7 through the hydrogen absorbing alloy cylinder 12, and thereby the hydrogen absorbing alloy cylinder 12 can store a larger amount of hydrogen gas as compared with a normal cylinder. Thus, the hydrogen absorbing alloy cylinder 12 serves as a storage.

The consumption of hydrogen gas from the hydrogen absorbing alloy cylinder 12 increases during the time when the load fluctuation is large, but when the load fluctuation is small, the amount of hydrogen gas produced by the hydrogen gas producer 11 exceeds the consumption of hydrogen gas. By supplying this excess hydrogen gas to the hydrogen absorbing alloy cylinder 12 (e.g., 7 atm), the storage amount in the hydrogen absorbing alloy cylinder 12 can be increased, and as a result, a smaller one as the hydrogen gas producer 11 can be selected to use.

The example in FIG. 5 shows a configuration partially incorporating the first aspect of the present invention and the second aspect of the present invention. That is, in this example, the sub-line 14 is connected to the main line 13, and a third line 18 is further used to send hydrogen gas from the hydrogen gas producer 11 to the hydrogen absorbing alloy cylinder 12.

In this example, when the load fluctuation is small, no hydrogen gas is sent to the air supply line 7 via the hydrogen absorbing alloy cylinder 12, but only hydrogen gas from the hydrogen gas producer 11 is sent.

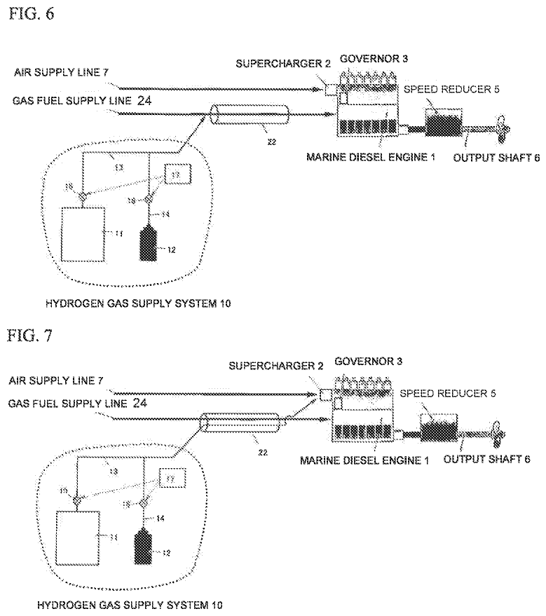

FIG. 6 shows an example in which a hydrogen gas supply system according to the third aspect of the present invention is applied to a marine diesel gas engine whose fuel is natural gas containing methane as the main component, petroleum gas containing propane or butane gas as the main component, or the like. In the third aspect of the present invention, since the combustion of the fuel gas is promoted and the fuel is completely combusted, the problem such as methane slip does not occur. Note that the same components as those in the above embodiment are designated by the same numbers, and the description thereof will be omitted. The gas engine encompasses any engine that performs not only combustion of gas fuel, but also switching combustion with liquid fuel, and co-combustion thereof.

Natural gas fuel containing methane as the main component and/or petroleum gas fuel are supplied to the engine 1 by a gas fuel supply line 24. A trace amount of hydrogen gas is sent to the gas fuel supply line 24 via the hydrogen gas supply system 10. When the pressure of the gas fuel is high, hydrogen gas is supplied through an ejector. For the fuel gas mixed with the hydrogen gas, in a safety compartment, the gas fuel supply line 24, which is an inner pipe, has an outer pipe 22 to form a double pipe structure, and the space between the gas fuel supply line 24 and the outer pipe 22 is filled with an inert gas such as nitrogen, or dry air is ventilated therethrough a predetermined number of times, so as to maintain safety.

The hydrogen gas produced by the hydrogen gas producer 11 is supplied to the gas fuel supply line 24 via the main line (piping) 13. In the third aspect of the present invention and the fourth aspect of the present invention also, the two (plural) hydrogen absorbing alloy cylinders 12 such as those in FIGS. 2A-2C can be used.

FIG. 7 shows a modified example of the example shown in FIG. 6. In the example, the main line 13 for supplying hydrogen gas is not merged with the gas fuel supply line 24 but with the air supply line 7, and the gas fuel supply line 24 is directly connected to the engine 1.

### REFERENCE SIGN LIST

1 Marine diesel engine

2 Supercharger

3 Governor

5 Speed reducer

6 Propeller shaft (Output shaft)

7 Air supply line (Piping)

10 Hydrogen gas supply system

11 Hydrogen gas producer

12 Hydrogen absorbing alloy cylinder (Canister)

13 Main line (Piping)

14 Sub-line

15, 16 Pressure regulating valves

17 Control device

18 Third line

19 Storage tank

22 Outer pipe

23 Temperature change preventive material

24 Gas fuel supply line

1. A system for supplying hydrogen gas to an engine including a gas engine, the system configured to supply hydrogen gas to an air supply line of the engine or a gas fuel supply line of the gas engine, the system comprising:
a main line configured to send hydrogen gas produced in a hydrogen gas producer by electrolysis to the supply line, the hydrogen gas being sent to promote mixing a fuel for the engine or the gas engine with supply air by combustion of the hydrogen gas so as to promote complete combustion;
a sub-line configured to send hydrogen gas from a hydrogen absorbing alloy cylinder to the main line;
a governor configured to maintain an engine rotation speed of the engine or the gas engine within a predetermined range; and
a control device configured to receive or send a signal, wherein
the governor sends a signal corresponding to the engine rotation speed to the control device,
a pressure regulating valve is disposed in the sub-line to be downstream with respect to the hydrogen absorbing alloy cylinder so as to regulate a supply amount of added hydrogen, and
an opening degree of the pressure regulating valve is adjusted based on a signal from the control device corresponding to the opening degree of the pressure regulating valve for supplying the added hydrogen with an amount according to a load state of the engine.

2. A system for supplying hydrogen gas to an engine including a gas engine, the system configured to supply hydrogen gas to an air supply line of the engine or a gas fuel supply line of the gas engine, the system comprising:
a main line, an end of the main line being connected to a hydrogen gas producer which uses electrolysis;
a hydrogen absorbing alloy cylinder disposed in a middle of the main line, hydrogen gas produced in the hydrogen gas being sent to the hydrogen absorbing alloy cylinder, and thereafter the hydrogen gas being sent from the hydrogen absorbing alloy cylinder to the supply line so as to promote mixing a fuel for the engine or the gas engine with supply air by combustion of the hydrogen gas and to promote complete combustion;
a governor configured to maintain an engine rotation speed of the engine or the gas engine within a predetermined range, and
a control device configured to receive or send a signal, wherein
the governor sends a signal corresponding to the engine rotation speed to the control device,
a pressure regulating valve is disposed in the main line to be downstream with respect to the hydrogen absorbing alloy cylinder so as to regulate a supply amount of added hydrogen, and
an opening degree of the pressure regulating valve is adjusted based on a signal from the control device corresponding to the opening degree of the pressure regulating valve for supplying the added hydrogen with an amount according to a load state of the engine.
